(19) United States
(12) Patent Application Publication
(10) Pub. No.: US 2021/0007518 A1
(43) Pub. Date: Jan. 14, 2021

(54) FOOD SECURING AUGER

(71) Applicant: Mark A. Wollam, Bonsall, CA (US)

(72) Inventor: Mark A. Wollam, Bonsall, CA (US)

(21) Appl. No.: 16/739,589

(22) Filed: Jan. 10, 2020

Related U.S. Application Data
(60) Provisional application No. 62/922,220, filed on Jul. 10, 2019.

(51) Int. Cl. A47G 21/02

(52) U.S. Cl. CPC A47G 21/02

(57) ABSTRACT

A utensil including: a first elongated shaft, a support disc; and a food gripping portion having a plurality of helical-shaped sections extending from a second elongated shaft.

### CROSS REFERENCE TO RELATED APPLICATIONS

This disclosure claims the benefit of U.S. Provisional Application No. 62/922,220 filed on Jul. 10, 2019, which is hereby incorporated by reference.

### TECHNICAL FIELD

This disclosure relates to food consumption, and more particularly to eating utensils.

### BACKGROUND

The statements in this section merely provide background information related to the present disclosure and may not constitute prior art.

An eating utensil is a common tool for aiding in preparing and consuming food. Some eating utensils, or cutlery, may include a fork, knife, or spoon. A spork is another well-known utensil. A fork, for example, generally includes a handle and tines extending outwardly from the handle. A spoon generally includes a handle and a relatively small oval or round bowl coupled to an end of the handle, the bowl portion shaped to hold sustenance. A knife also typically includes a handle and a cutting blade at an end of the handle. The spork is a combination spoon and fork.

Known eating utensils have a relatively weak ability to secure food. Therefore, an improved utensil for securing food is needed.

### SUMMARY

A utensil including: a first elongated shaft, a support disc; and a food gripping portion having a plurality of helical-shaped sections extending from a second elongated shaft. In various embodiments, the plurality of helical-shaped sections forms a discontinuous helical spiral of one to three turns in axial alignment with the elongated shaft.

In some embodiments, the utensil includes: a first elongated shaft for holding by a user, a support disc, substantially perpendicular to the first elongated shaft, and a gripping portion having a plurality of helical-shaped sections extending from a second elongated shaft, the second-elongated shaft in axial alignment to the first elongated shaft. The plurality of helical-shaped sections can includes a first and a second helical-shaped sections being in helical alignment to form a near complete helical turn, and a third and a fourth helical-shaped sections being in helical alignment to form a second near complete helical turn.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 is a front isometric view of an exemplary food auger, in accordance with the present disclosure;

FIG. 2 is a second isometric view, in accordance with the present disclosure;

FIG. 3 is a first side view, in accordance with the present disclosure;

FIG. 4 is a second side view, in accordance with the present disclosure;

FIG. 5 is a third side view, in accordance with the present disclosure;

FIG. 6 is a fourth side view, in accordance with the present disclosure;

FIG. 7 is a top view, in accordance with the present disclosure;

FIG. 8 is a bottom view, in accordance with the present disclosure;

FIG. 9A is a cross-sectional view taken along line A-A shown in FIG. 3, in accordance with the present disclosure;

FIG. 9B is a cross-sectional view taken along line B-B shown in FIG. 3, in accordance with the present disclosure;

FIG. 9C is a cross-sectional view taken along line C-C shown in FIG. 3, in accordance with the present disclosure; and

FIG. 10 depicts an exemplary use of the food auger, in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

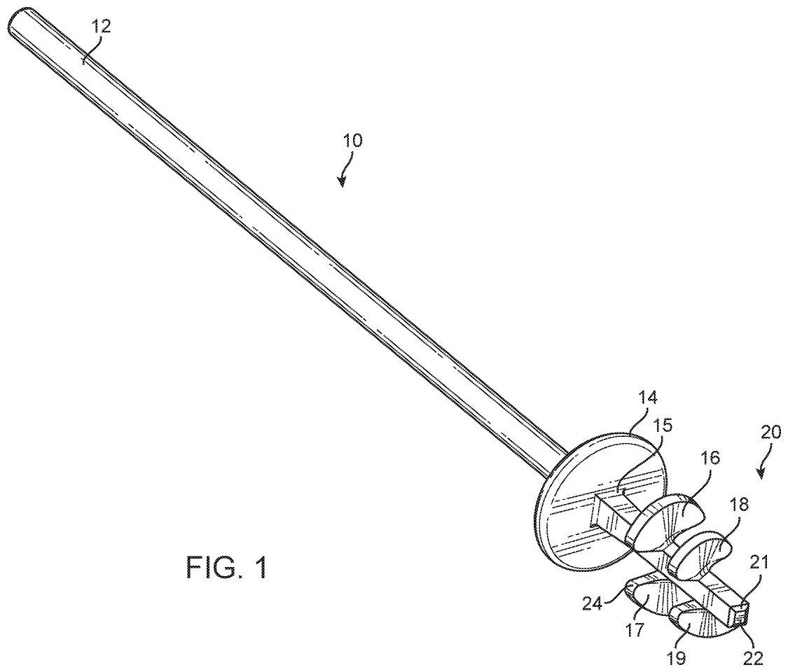

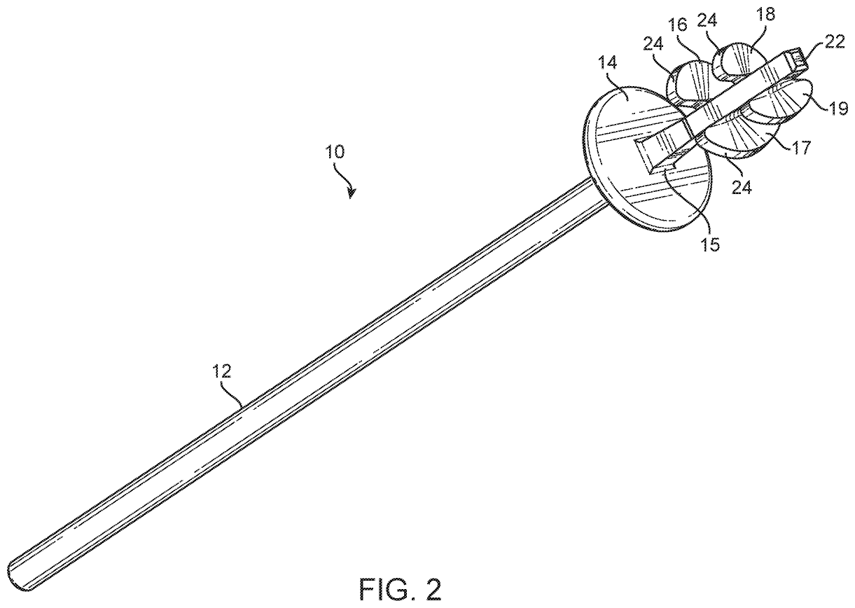

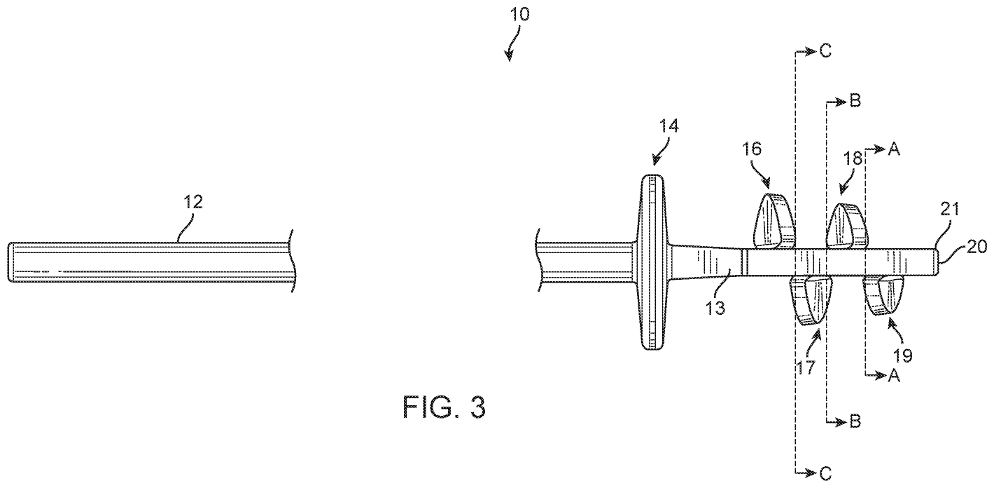

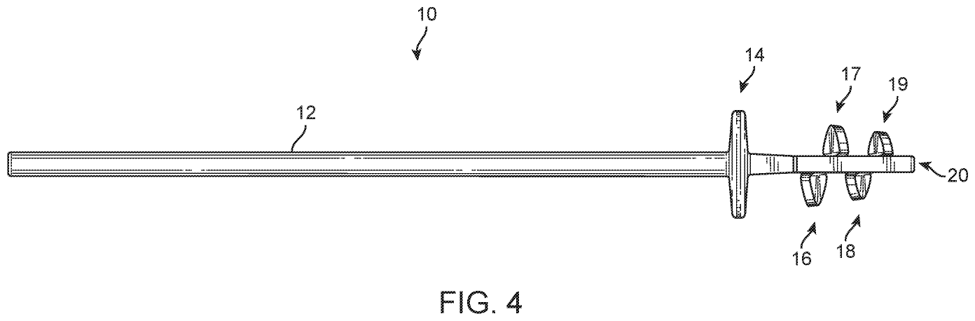

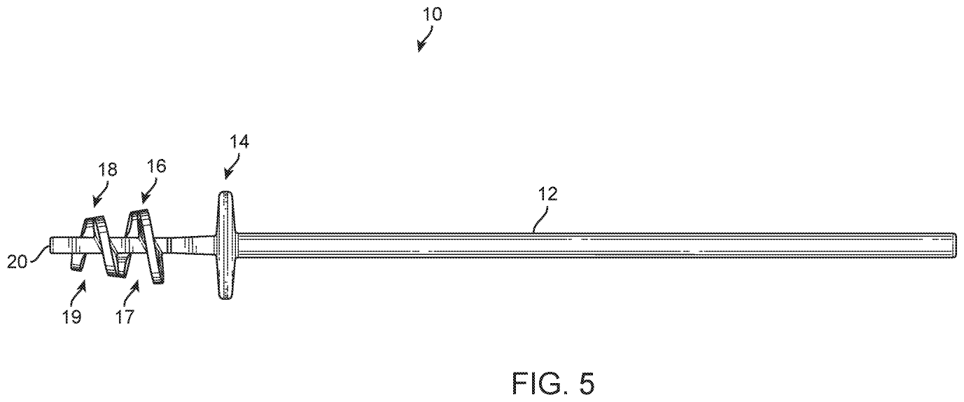

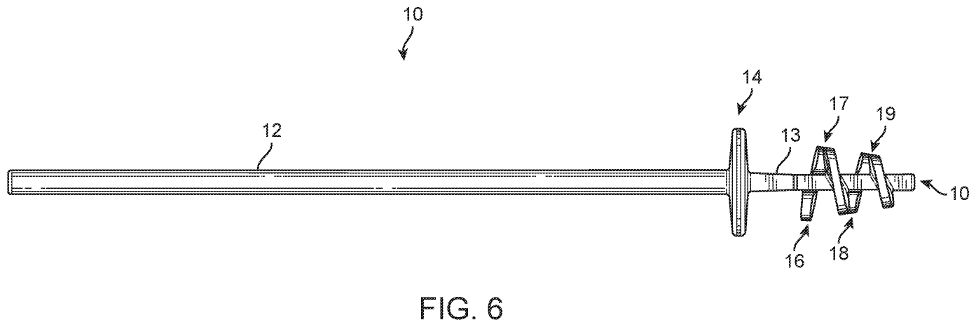

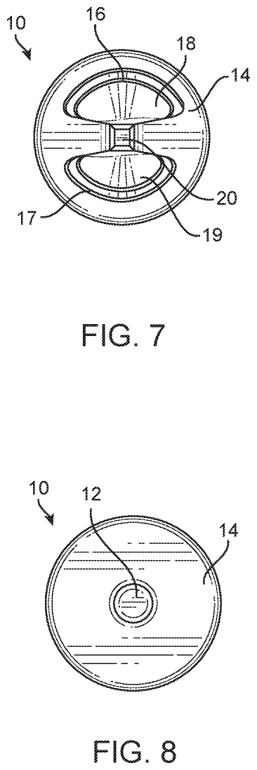

Referring now to the drawings, wherein the depictions are for the purpose of illustrating certain exemplary embodiments only and not for the purpose of limiting the same, FIGS. 1-8 show an exemplary utensil, i.e., a food auger 10 in accordance with the present disclosure. The food auger 10 includes a shaft portion 12, a support disc 14, and a gripping portion 20.

The exemplary food auger 10 is preferably integrally formed of polymer-based materials, e.g., plastic, but may be formed of most any non-coercive food-safe material. In one embodiment, the food auger 10 is produced via injection molding of polymers such as polyethylene, polypropylene, polycarbonate, polystyrene, or ABS, or various combinations of polymers to yield desirable physical characteristics in the production of the food auger 10. Other non-polymeric materials can be used, including metals and metal alloys. It will therefore be appreciated by those skilled in the art that yet other modifications could be made to the food auger 10 without deviating from its spirit and scope as disclosed herein.

In one embodiment, the food auger 10 is non-integrally formed. For example, the shaft 12 may be coupled to the support disc 14. In another embodiment, the shaft 12 and support disc 14 may be coupled to the gripping portion 20.

The shaft 12 is shown in the figures as substantially cylindrical-shaped elongated member. It is contemplated herein that the shaft 12 may be shaped or sized in most any way provided that a user can hold and manipulate the food auger 10. In one embodiment, the shaft 12 is ergonomically-shaped. In one embodiment, the shaft 12 is an elongated rectangular, cross-sectional shaped member.

The support disc 14 is shown in the figures as a saucer-like shape, i.e., an elliptical disc-shape having rounded edges. In various embodiments, the support disc 14 may be alternatively shaped such as having an oval saucer shape, or a polygonal saucer shape such as a tetragonal saucer shape, or an octagonal saucer shape. Having a substantially flat planar top and bottom surface is preferable, as the bottom surface leaves more space to hold the shaft 12, but may also function to provide mechanical leverage when pressed by a user's hand. On the top surface, the surface proximate to the gripping portion 20, the surface is preferably flat so as to leave space for the foodstuff.

The support disc 14 is preferably perpendicular to the shaft 12. In one embodiment, the support disc 14 is integrally attached to one or more gussets 15 to provide support to the shaft 12. Gussets 15 may be included on the top and bottom of the support disc 14. The support disc 14 has a radial extent from the shaft 12 that is greater than the radial extent of the auger sections 16, 17, 18, and 19.

The gripping portion 20 includes a plurality of auger sections 16, 17, 18, and 19 protruding from a top shaft 13. The auger sections 16, 17, 18, and 19 are axially aligned. The auger sections 16, 17, 18, and 19 are helically aligned, i.e., the sections are in phase and not offset. In various embodiments, the auger sections 16, 17, 18, and 19 form nearly two helical turns. In various embodiments, the pitch of sections 16 and 17 is the same as the pitch between section 18 and 19, although it is contemplated herein that the pitch in other embodiments may be different, e.g., smaller or larger.

As shown, each section 16, 17, 18, and 19 covers slightly less than 180-degrees helical or radial arc around the shaft 12, i.e., each section shown wraps or extends around the shaft 12 slightly less than a half turn. In various embodiments, the sections may range from one quarter turn to one turn. To put is another way, a radial arc of each of the sections 16, 17, 18, and 19 may be between approximately 45 degrees and approximately 180 degrees in various embodiments, circumferentially around the shaft 12. In one embodiment, sections 16 and 17 have opposing radial arcs extending from the shaft 13, and 18 and 19 have opposing radial arcs extending from the shaft 13. In one embodiment, sections 16 and 18 have substantially the same radial arc, and sections 17 and 19 have substantially the same radial arc.

In various embodiments, the sections 16, 17, 18, and 19 may form a continuous helical spiral of one to three turns. As shown, the sections 16, 17, 18, and 19 are a discontinuous helical spiral formed of sections spaced in helical alignment.

The radial extent of each section 16, 17, 18, and 19 may have a circular or elliptical shape observed in plan with respect to the axis of rotation. As shown, sections 16 and 17 have a greater radial size than sections 18 and 19 with respect to the shaft 12. In various embodiments, each of the sections 16, 17, 18, and 19 may have progressively decreasing radial size with respect to the shaft 12.

In some embodiments, a section near most an end 22 of the shaft 12, such as section 19 in the embodiment shown, may have an outer edge that may begin to be reduced in size and taper inward toward the central shaft 12 so as to eventually become flush with the central shaft 12. In this embodiment, the section may form more than one-half turn of the helical shape.

In various embodiments, edges 24 of the sections 16, 17, 18, and 19 may define the helical shape. That is, the edges 24 of the sections 16, 17, 18, and 19 are helically aligned, the interior portions of the sections being perpendicular to the shaft 12 and radially extending to the edges 24.

As the figures show, the top shaft 13 is an elongated member having a substantially rectangular cross-sectional shape. The top shaft 13 is preferably is axial alignment with the shaft 12. Sections 16 and 18 extend from a first side of the shaft 13, while sections 17 and 19 extend from an opposing side. In one embodiment, the shaft 13 has a square cross-sectional shape. The shaft 13 extends to the support disc 14 via the gussets 15. In one embodiment, the shaft 13 gradually tapers from the support disc 14 to the end 20. In one embodiment, the shaft 13 has edges 21 on the end 20 reduced, such as via rounding or chamfered, as shown, to avoid having a sharp edge.

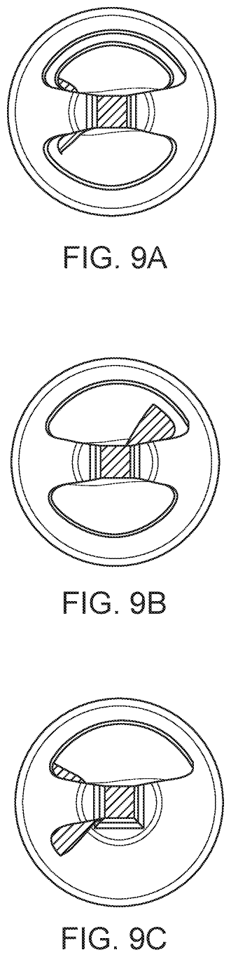

FIGS. 9A-9C show the food auger 10 in various cross-sectional views. As FIGS. 9A-9C show, the sections 16, 17, 18 radiate from the shaft 13.

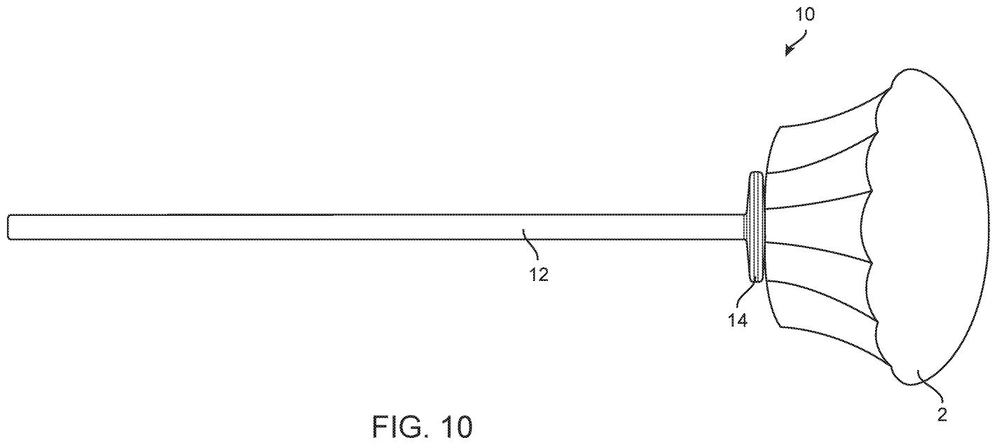

FIG. 10 shows the food auger 10 in use. As FIG. 10 shows, the food auger 10 may be used to pickup or secure food such as the illustrative cupcake 2. In use, a user rotates the utensil 10 into a food item, which screws or pulls the food auger 10 into the food.

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. A utensil comprising:
a first elongated shaft;
a support disc; and
a gripping portion having a plurality of helical-shaped sections extending from a second elongated shaft.

2. The utensil of claim 1, wherein the diameter of the support disc is greater than the radial extent of the plurality of helical-shaped sections.

3. The utensil of claim 1, wherein the first elongated shaft is in axial alignment with the second elongated shaft.

4. The utensil of claim 1, wherein the support disc is saucer-shaped.

5. The utensil of claim 1, wherein the support disc includes gussets.

6. The utensil of claim 1, wherein the support disc is perpendicular to the first elongated shaft.

7. The utensil of claim 1, wherein the plurality of helical-shaped sections comprises:
a first and a second helical-shaped sections being in helical alignment to form a near complete helical turn.

8. The utensil of claim 7, wherein the plurality of helical-shaped sections further comprises:
a third and a fourth helical-shaped sections being in helical alignment to form a near complete helical turn.

9. The utensil of claim 8, wherein the first, second, third, and fourth helical-shaped sections each have a radial arc extending nearly 180-degrees with respect to the second elongated shaft.

10. The utensil of claim 9, wherein the first and second helical-shaped sections have opposing radial arcs.

11. An integral utensil comprising:
a first elongated shaft for holding by a user;
a support disc, substantially perpendicular to the first elongated shaft; and
a gripping portion having a plurality of helical-shaped sections extending from a second elongated shaft, the second-elongated shaft in axial alignment to the first elongated shaft.

12. The utensil of claim 11, wherein the diameter of the support disc is greater than the radial extent of the plurality of helical-shaped sections, and wherein the support disc is integrally formed to the first elongated shaft and coupled thereto via gussets and integrally formed to the second elongated shaft and coupled thereto via a second set of gussets.

13. The utensil of claim 11, wherein the plurality of helical-shaped sections comprises:
a first and a second helical-shaped sections being in helical alignment to form a near complete helical turn; and
a third and a fourth helical-shaped sections being in helical alignment to form a second near complete helical turn.

14. The utensil of claim 13, wherein the first, second, third, and fourth helical-shaped sections each have a radial arc extending nearly 180-degrees with respect to the second elongated shaft.

15. The utensil of claim 14, wherein the first and second helical-shaped sections have opposing radial arcs, and the third and fourth helical-shaped sections have opposing radial arcs.

16. The utensil of claim 11, wherein the second-elongated shaft has a rectangular cross-sectional shape, and wherein the first and third helical-shaped sections have a radial arc extending from a first side of the second-elongated shaft, and wherein the second and fourth helical-shaped sections have a radial arc extending from a second side of the second-elongated shaft.

17. The utensil of claim 11, wherein a pitch between the first and second helical-shaped sections is greater than a pitch between the third and the fourth helical-shaped sections, and a radial extent of the first and the second helical-shaped sections is greater than a radial extent of the third and the fourth helical-shaped sections.

18. A utensil comprising:
an elongated shaft for holding by a user;
a support disc, substantially perpendicular to the first elongated shaft; and
a helical spiral of one to three turns in axial alignment with the elongated shaft.

19. The utensil of claim 17, wherein the helical spiral is discontinuous, having radial arc voids in the helical spiral of less than 5-degrees.

20. The utensil of claim 18, further comprising:
a second elongated shaft in axial alignment to the first elongated shaft, wherein the second-elongated shaft has a rectangular cross-sectional shape, and wherein a first and a third helical-shaped section of the helical spiral have a radial arc extending from a first side of the second-elongated shaft, and wherein a second and a fourth helical-shaped sections have a radial arc extending from a second side of the second-elongated shaft; and
wherein a pitch between the first and second helical-shaped sections is greater than a pitch between the third and the fourth helical-shaped sections, and a radial extent of the first and the second helical-shaped sections is greater than a radial extent of the third and the fourth helical-shaped sections.
